(19) United States
(12) Patent Application Publication
(10) Pub. No.: US 2005/0016700 A1
(43) Pub. Date: Jan. 27, 2005

(54) Isolation of sclereids

(75) Inventors: John David Hoffmann, Burnaby (CA); Robert W. Gooding, Montreal (CA)

Correspondence Address: OGILVY RENAULT, 1981 MCGILL COLLEGE AVENUE, SUITE 1600, MONTREAL, QC, H3A2Y3, CA

(73) Assignee: Pulp and Paper Research Institute of Canada

(21) Appl. No.: 10/895,361

(22) Filed: Jul. 21, 2004

Related U.S. Application Data
(60) Provisional application No. 60/489,483, filed on Jul. 24, 2003.

(51) Int. Cl. D21C 9/08; B01D 21/26

(52) U.S. Cl. 162/55; 210/512.2; 406/173

(57) ABSTRACT

A sclereid concentrator is an apparatus designed to concentrate sclereids found in pulp. The sclereid concentrator is based around a mini-hydrocyclone. When a slush pulp sample is passed through the mini-hydrocyclone, practically all the sclereids are removed by the reject port. The reject sample is then collected, screened and the sclereids are then manually counted or an image analysis system is used to automatically count the sclereids. This count, expressed on the basis of the original sample mass, gives an accurate measurement of the sclereid contamination level in the pulp. There is provided a sclereid concentrator device, a procedure to produce almost pure sclereids and a method to count sclereids manually or by image analysis.

### BACKGROUND OF THE INVENTION

This invention relates to a method and apparatus for isolation of contaminants in wood pulp, specifically sclereids, for the purpose of measuring sclereid contamination levels.

### DESCRIPTION OF THE PRIOR ART

Sclereids form naturally in the inner bark of most trees but are considered contaminants when found in pulp or paper. It is becoming increasingly important for mills that produce pulp or paper to accurately know what the sclereid contamination level of their products is.

Sclereids are dense cellulosic inclusions found in many plants, including both hardwood and softwood trees, used in papermaking pulps. Sclereids can cause a variety of problems in papermaking, calendering, coating and converting operations. For instance, in papermaking mills where high-speed paper machines are employed, the sclereids may produce areas of weakness on the forming sheet, resulting in more frequent breakage thereof. Breaks on the paper result in down time and loss of production. In the finished paper, they may produce blemishes, reduce the visual quality of the paper and result in non-uniform reception of printing inks. There are few tests available for measuring sclereid inclusions in pulp and paper, and they are mainly empirical, based on human observation and manual count.

At present there is little published literature on sclereid measurement techniques. Below are listed the literature references that do cite method(s) for sclereid measurement:
1. Forster, S. Sclereid control at Canfor Prince George. 1987 Spring Conference Preprints, CPPA Technical Section, 1987.
2. Ringdahl, L. Replacing bleached-pulp cleaning system improves quality at Tahsis. Pulp and Paper 54(3), 1980:96-98.
3. Thair, B. W. and Corcoran, P. J. A quantitative method for the measurement of sclereid clusters in bleached softwood kraft pulp. 1979 Spring Conference Preprints, CPPA Technical Section, 1979.

Below are listed U.S. patents or patent applications that may be considered to provide information in the field of sclereid measurement:
1. US 2003/0076492 A1 Apr. 24, 2003 “Identification of material inclusions in pulp and paper using Raman spectroscopy” James E. Bradbury, Donald R. Smith, Edward R. Grant, and Philipp Kukura.
2. US 2003/0020029 A1 Jan. 30, 2003 “Method and apparatus for determining stone cells in paper or pulp” Deborah Jean Henry, Ross S. Chow, and Hongqi Yuan.
3. U.S. Pat. No. 5,542,542 Aug. 6, 1996 “System for detecting contaminants” John D. Hoffmann, Robert W. Gooding, Norman Roberts, and Robert S. Hart.
4. U.S. Pat. No. 5,087,823 Feb. 11, 1992 “Device for determining the characteristics of particles in suspension in a liquid” Jacques Silvy and Rene Pascal.
5. U.S. Pat. No. 4,758,308 Jul. 19, 1988 “System for monitoring contaminants with a detector in a paper pulp stream” Wayne F. Carr.

The first patent listed above (Bradbury et al, US 2003/0076492 A1) employs a laser Raman spectroscopic probe to generate Raman spectroscopic images of pulp, paper and contaminant samples. A spectroscopic finger print of each material or mixtures of materials is placed in a data base and used to identify unknown samples.

In literature the term sclereid and stone cell are often used interchangeably. Unfortunately, the term stone cell does not always refer to a sclereid and, therefore, to prevent ambiguity, the use of the phrase “stone cell” should be avoided. Stone cells can also refer to phellem cells. Phellem cells have a flat, disk like shape with a cog wheel patterned cell structure.

The second patent publication listed above (Henry et al, 2003/0020029 A1) describes a device that irradiates paper or pulp samples with light of a specific range of wavelengths. This incident light causes the sclereids to fluoresce strongly relative to the background matrix of pulp or paper. The strongly fluorescing sclereids are observed and counted or they are digitally recorded using a camera.

The third patent listed above (Hoffmann et al, U.S. Pat. No. 5,542,542) is assigned to Paprican and covers a plastic detection device available under the trade-mark Paprispec®. In this device a hydrocyclone (cleaner) is used to concentrate lightweight contaminants in its reject flow. The contaminants are then transferred into a mini-screen to separate fiber from contaminants. The cleaner is typically operated at a solids content range of 0.3 to 1.5%. Pulp is fed through the cleaner in a single pass arrangement. The cleaner is a “flow through” design characterized by the accept port exiting near the base of the cleaner and the reject port exiting at the base of the cleaner. More importantly, this style of cleaner is designed to concentrate lightweight contaminants in the reject flow.

The fourth patent listed (Silvy et al, U.S. Pat. No. 5,087,823) encompasses a device for measuring fiber length. This device can also be used to calculate the ratio between organic and mineral elements in a furnish or used to indicate how efficient retention control is on the paper machine. The device includes a pulp sampler, a fractionator, an optical measurement cell and a programmable controller.

This device is interesting in the sense that it may be configured to measure sclereids in pulp yet its process is quite different from our sclereid measurement technique. The fractionator device does not use a hydrocyclone in its construction. The approach consists of an optical measurement cell to image and count particles.

The fifth patent listed (Carr, U.S. Pat. No. 4,758,308) uses one or more cleaners to split a pulp containing contaminants into heavy, medium and small sized particle fractions. The particle removal includes sequential stages for removing the heavy, medium and small sized contaminants. These contaminants are passed through an illuminated photodetecting unit in the form of a thin sheet like flow. When a contaminant particle travels past the linear array of photosensitive elements, the momentary shadowing or blocking of the illumination on the elements produces a drop in analog signal output. This analog output is then digitized, and with the help of a computer and related software, contaminant quantity and size distributions can be produced.

Carr states that “ . . . particle removal includes sequential stages for removing the heavy, medium and small sized contaminants.” Judging by Carr's patent figures and description, sequential stages means one or both outputs of the primary cleaner can be directed into a secondary cleaner and the secondary cleaner accepts can be redirected back into the primary cleaner. Motor driven pumps are used to supply pressurized pulp slurry to the feed port of each cleaner.

In the pulp and paper industry there is no standard or officially recognized method for sclereid measurement. This is most likely due to the fact that sclereid contamination has only become a serious concern in the pulp and paper industry within the last five years or so.

Up till now mills have been left up to their own devices when it comes to finding or developing a sclereid measurement method for their mill. As a result, there are many different sclereid measurement methods in use today. We looked at all of the methods we could find and performed a comprehensive evaluation on two of the most promising ones—“the black tray” and “the pressed handsheet” methods. The evaluation showed these two techniques could track sclereid concentration trends but both had a high level of error.

### SUMMARY OF THE INVENTION

It is an object of this invention to provide a method of isolating sclereid contamination in a pulp for the purpose of evaluating the level of such contamination.

It is another object of this invention to provide an apparatus for isolating sclereid contamination in a pulp for the purpose of evaluating the level of such contamination.

It is still another object of this invention to provide a method for determining the level of sclereid contamination in a pulp.

It is yet another object of this invention to provide an apparatus for determining the level of sclereid contamination in a pulp.

In accordance with a particular embodiment of the invention, there is provided a method of isolating sclereid contaminants from pulp fibers in a pulp sample comprising: providing an aqueous suspension of a known amount of a pulp sample in a flow chamber, withdrawing the suspension from said chamber and entraining the suspension in an aqueous dilution stream to produce a highly diluted suspension, and feeding the highly diluted suspension into a hydrocyclone and separating a sclereid fraction from a pulp fiber fraction in said hydrocyclone.

In accordance with another particular embodiment of the invention, there is provided a method for determining the level of sclereid contamination in a pulp comprising isolating sclereid contaminants in accordance with the invention, as described herein, recovering the isolated sclereids and evaluating the isolated sclereids as a measure of contamination of the pulp.

In accordance with still another particular embodiment of the invention, there is provided an apparatus for isolating sclereid contaminants from pulp fibers in a pulp sample comprising: a flow chamber for flow therethrough of a suspension of a known amount of the pulp sample; a flow passage for flow of an aqueous dilution stream, and means to withdraw the suspension from said flow chamber into said flow passage for entrainment in the aqueous dilution stream, as a highly diluted suspension; a hydrocyclone, said flow passage being in flow communication with said hydrocyclone for delivery of the highly diluted suspension to the hydrocyclone; the hydrocyclone being adapted to separate a sclereid fraction from a pulp fiber fraction of the suspension, the hydrocyclone having a first outlet port for the pulp fiber fraction and a second outlet port for the sclereid fraction; said second outlet port being in communication with said flow chamber for return of the sclereid fraction thereto.

In accordance with yet another particular embodiment of the invention, there is provided an apparatus for determining the level of sclereid contamination in a pulp comprising an apparatus of the invention for isolating sclereids, as described herein, and further including means for recovery of isolated sclereids for evaluation.

### DETAILED DESCRIPTION OF INVENTION

In the operation of the methods of the invention, the separated sclereid fraction is preferably returned to the flow chamber and recycled into the aqueous dilution stream for return to the hydrocyclone for further separation a plurality of times, to produce a progressively sclereid enriched sclereid fraction.

Suitably, the flow chamber is vertically elongate and the suspension therein flows vertically downwardly under a condition of plug flow.

Suitably, the highly diluted suspension has a solids content, comprising pulp fibers and sclereids of not more than 0.1%, by weight.

The withdrawal of suspension from the flow chamber is suitably carried out with an eductor in the flow passage, effective to suction the suspension from the flow chamber into the flow passage for entrainment by the aqueous dilution stream. Typically, the apparatus has a flow path for the suspension, including the flow chamber, the eductor and the flow passage, which flow path provides for minimal mechanical impact forces on the sclereids.

The sclereid concentrator is the first device used in the sclereid measurement procedure. The concentrator is used to remove most of the fibrous material from a pulp sample. Typically a ten gram sample is placed in the concentrator and the device is turned on. The pulp sample will circulate through the concentrator's mini-hydrocyclone (cleaner) 1 to 10, preferably 5 to 7, and more especially 6 times. After each pass a portion of the sample's fiber will be removed by the accept or overflow port of the hydrocyclone. Following the final pass, more especially the sixth pass, the remaining material will be deposited into a collection cup. At this point the sample mass has been reduced by approximately 95%, yet virtually all the sclereids remain.

In the second step the sclereid sample is run through a screen, for example, the Pulmac “Master Screen” or Pulmac “Shive Analyser” fitted with a slotted screen plate; by way of example there may be mentioned a 0.004″ slotted screen plate or a 0.006″ slotted screen plate; the latter might suffer from excessive sclereid loss. After the screening step, there should be virtually no fiber remaining in the sclereid sample. The sample is then placed under a low power stereo microscope and the sclereids are identified and counted. Alternatively, the sclereid sample is placed on a flat bed scanner, an image made, and a personal computer based image analysis program counts and measures the particle size distributions.

In this sclereid measurement procedure the function of the concentrator is to remove most of the pulp fiber, fibrous material like fiber knots, knife knits, strings, and any other lightweight or high specific surface particles. If the concentrator step were to be removed from the procedure, the result would be more residual fiber and other fibrous material, remaining in the final sclereid sample.

When rapidly identifying and counting sclereids, it is important to have a sample that is free of materials such as pulp fiber, knits, strings, and shives. The concentrator employed in the invention reduces the initial sample fiber mass by 95%. This allows the remaining 5% of fiber to be easily removed by the subsequent screening step, thus producing a sclereid sample with few other contaminants.

The proposed sclereid concentrator apparatus uses a hydrocyclone or cleaner. The concentrator employs a “forward cleaner” design that is efficient at removing heavy weight contaminants in the reject flow. The forward cleaner design is characterized by having the accept port located at the cleaner top and a reject port at the cleaner base. In this application the cleaner is operated at much lower solids content than normal, 0.01 to 0.1%, and is configured to, run in a sequential, multiple pass mode. Also, the cleaner on the sclereid concentrator operates at relatively low feed pressures of about 20 psi.

The sclereid concentrator device uses only one cleaner (hydrocyclone) and the reject flow from it is continuously redirected back to the cleaner feed via an eductor. In this configuration the sclereid concentrator is able to pass the same reject sample through the same cleaner many times, over a relatively short time period (5 min.). The purpose of each pass is to further reduce the residual fiber component of the sclereid sample. The sclereid concentrator does not use a motor driven pump to reintroduce the cleaner reject sample back into the cleaner feed. The suction produced by the flow of cleaner feed water traveling through the eductor produces suction on a side port that draws in, mixes and dilutes the cleaner reject sample en route to the cleaner feed port.

The concentrator comprises the flow chamber, the flow passage, and the hydrocyclone.

An eductor in the flow passage has a venturi passage, and flow of the dilution stream therethrough creates a vacuum effect, suctioning the suspension from the flow chamber into the flow passage where the suspension is entrained by the flowing dilution stream, and a further dilution of the suspension is effected prior to delivery of the suspension to the hydrocyclone.

The process commences with a relatively dilute suspension of the pulp sample, with further dilution in the flow passage. The high dilution is of importance in ensuring a low concentration suspension of fibers and sclereids, particularly such that collisions between the particles are minimized, individual fibers and sclereids being well spread apart in the suspension, avoiding agglomeration or adhesion between particles so that an efficient separation of fibers from sclereids is achieved in the hydrocyclone, and there is minimal loss of sclereids with the fiber fraction removed from the hydrocyclone.

The use of the eductor avoids the need for mechanical pumps of the type in which impellers apply impacts to force the liquid flow.

The flow of the suspension in the invention is such that the suspension is not subjected to mechanical impelling forces, and the particles in the flow of entrained suspension, in the flow passage, will suffer minimal impacts with each other, and with the walls of the passage.

It is believed the hydrocyclone separates the sclereid particles based primarily on specific surface area. The suspension is introduced tangentially into the hydrocyclone and the lower specific surface area particles, namely, the sclereids, remain adjacent the interior wall of the hydrocyclone while the higher surface area particles, namely, the pulp fibers, migrate to the center of the hydrocyclone.

The flow chamber is suitably vertically elongate, and the suspension flows therethrough under a condition of plug flow so that a sclereid fraction entering the flow chamber from the hydrocyclone is not mixed with an earlier fraction. Consequently, the suspension in the flow chamber becomes progressively poorer in pulp fibers as the suspension is recycled along the flow path which is defined by the flow chamber, flow passage, and hydrocyclone.

The invention permits a 10 gram pulp sample to be distilled down to just sclereids in a simple and quick two-step process, thereby allowing easy identification and summation of the sclereid contaminants.

### BRIEF DESCRIPTION OF THE DRAWING

FIG. 1 is a schematic representation of an apparatus of the invention for carrying out the methods of the invention.

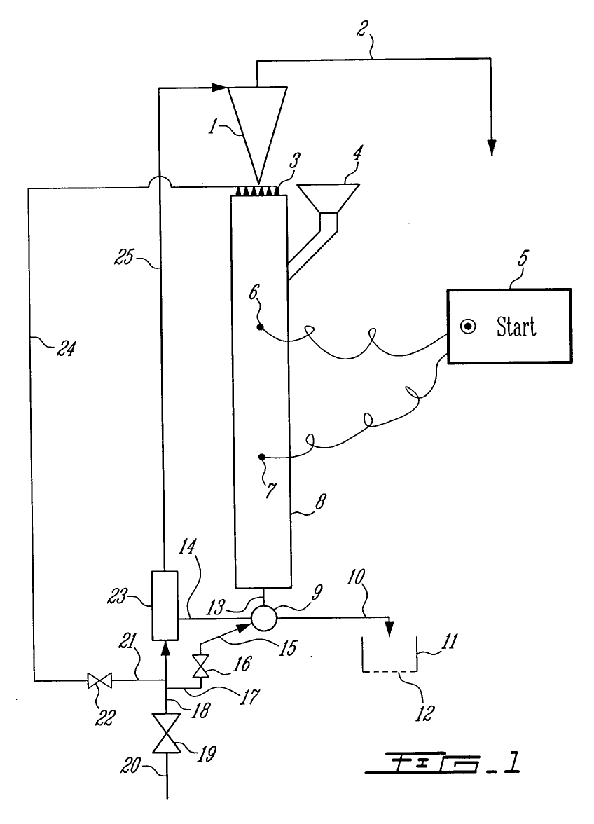

### DESCRIPTION OF THE PREFERRED EMBODIMENTS WITH REFERENCE TO THE DRAWING

With further reference to the drawing, the following components are identified:
(1) hydrocyclone (cleaner)
(2) accept line—from cleaner to drain
(3) shower head—rinses Plexiglas tube tank walls, also adds dilution water
(4) sample funnel—used to introduce pulp sample into Plexiglas tube tank
(5) system controller—controls test timing and the operation of all electrically actuated valves—wires connect it to the upper and lower level sensors and valves
(6) upper level sensor—indicates whether fluid level is above or below this point
(7) lower level sensor—indicates whether fluid level is above or below this point
(8) Plexiglas tube tank—contains sample at start of test, produces “plug flow” effect
(9) three way ball valve—switches the flow from feeding the eductor to feeding the sample cup
(10) pipe line—from three way ball valve to sample cup
(11) sample cup—sclereid/fiber mixture is deposited here after test is complete
(12) wire mesh—sample cup bottom is lined with 150 mesh stainless steel wire mesh to allow water to rapidly drain through it
(13) pipe line—from Plexiglas tube tank to three way ball valve
(14) pipe line—from three way ball valve to eductor
(15) pipe line—feeds flush water to three way ball valve
(16) two way valve—turns on or off the flush water directed at the three way ball valve, valve is controlled by system controller (5)
(17) pipe line—from main water supply line to the two way valve (16)
(18) pipe line—main water supply line, feeds the eductor
(19) two way valve—turns flow of water on or off in the main water supply line, valve may be controlled by system controller (5)
(20) pipe line—main water supply line, feeding two way valve (19)
(21) pipe line—carries flush water from the main water supply line to the two way valve (22)
(22) two way valve—turns on or off flow of water to tube tank showers, valve is controlled by system controller (5)
(23) eductor—driven by flow of fresh water through it, draws in pulp sample from tube tank (via pipe line (13), through three way ball valve (9) and pipe line (14)) and blends/dilutes it with fresh water and sends the mixture out line (25)
(24) pipe line—carries fresh water from valve (22) to shower head
(25) pipe line—carries water pulp/blend from eductor (23) to the hydrocyclone (1)

This description covers both the method and the novel apparatus used in the sclereid measurement procedure of the invention. The details will follow the natural order of the sclereid measurement procedure.

The concentrator consists of five main components: a mini-hydrocyclone or cleaner (1), a Plexiglas “tube tank” (8), an actuated three-way ball valve (9), an eductor (23) and an electronic controller (5).

At the beginning of the test, the Plexiglas tube tank (8) is filled with a 10 gram slush pulp sample. Before the pulp has had a chance to settle in the tube tank (8), the main water supply line valve (19) is fully opened and the system controller button is triggered (5). When the main water supply line valve is opened, fresh water flows from pipe line (20), through valve (19), up pipe line (18), through the eductor (23), up pipe line (25), and into the hydrocyclone (cleaner) (1). Once inside the cleaner (1), the water flow splits into two paths; one flows out the top of the cleaner and the other out the bottom. The majority of the flow coming into the cleaner (1) exits out the top and is carried to the drain by pipe line (2). A small portion of the flow fed to the cleaner (1) exits out the bottom (reject port) and free falls into the Plexiglas tube tank (8).

At this point the Plexiglas tube tank (8) is full of pulp and cannot accept much more water. As the fresh water flows through the eductor (23), a vacuum is produced in the eductor's side port—which is connected to pipe line (14). This vacuum draws the pulp sample out of the Plexiglas tube tank (8), out pipe line (13), through the three way ball valve (9), in pipe line (14) and finally into the eductor (23). In the eductor (23) the pulp sample is diluted and mixed with fresh water, and then sent through pipe line (25) to the cleaner (1). The cleaner then sends most of the fiber and other low density or high specific surface particles out the accept line (2) to the drain. Sclereids along with some coarse fiber/shives pass out the cleaner reject port and free fall back into the Plexiglas tube tank (8).

To ensure the tube tank (8) does not overflow, the eductor (23) is sized so that the flow out the tube tank bottom is always greater than the feed into the top of it from the cleaner reject port. If the tube tank level drops too low, air could become entrained into the flow circuit, affecting the performance of the eductor (23) and cleaner (1). To prevent air entrainment and to ensure no pulp sticks to the tube tank walls, a shower head (3) system is incorporated in the concentrator. As the fluid level drops past the low level sensor (7), the system controller (5) opens the two way valve (22) to allow fresh water from pipe line (18) into line (21), through valve (22), up line (24) and through the shower head (3). Once the shower is activated, the fluid level in the tube tank (8) rises until it reaches the upper level sensor (6) which causes the system controller (5) to close the two way valve (22) and stops the flow of shower water. The system controller thus maintains the level of fluid in the tube tank (8) between the upper and lower level sensors (6, 7).

The test ends when the pulp sample has been re-circulated through the eductor/cleaner loop six times. At this point a timer in the system controller trips into “drain” mode and causes the three way ball valve (9) to rotate ninety degrees, allowing the pulp/sclereid mixture in the tube tank (8) to drain out pipe line (10) into the sample cup (11). The system controller (5) keeps the shower water on (two way valve (22) open) to help rinse any residual sclereids into the sample cup (11).

A rinse water line is also turned on during the drain mode. Two way valve (16) is opened, allowing fresh water into pipe line (17), through valve (16), in pipe line (15) and flushing out the closed port of the three way valve (9), pipe line (14), the eductor (23), pipe line (25), the cleaner (1), the tube tank (8), pipe line (13), the open port of the three way ball valve (9) and pipe line (10).

The contents of the sample cup are then used in the subsequent Pulmac screening step and a microscope counting step. The full procedures of the sclereid measurement method in a specific example are set out below.

Sclereid Measurement Procedure

Required Equipment:
Sclereid concentrator device
Pulmac Shive Analyzer or Master Screen fitted with an accurate 0.004″ screen plate.
Low power good quality stereo microscope (approx. 6 to 40 times magnification)
Black, ruled, 42.5 mm diameter, filter paper disks
Vacuum filter holder
Stainless steel spatula
Dissecting probe
Stainless steel dissecting forceps, with smooth needle point
Plastic petri dishes, 50 mm diameter, used to store sclereid samples
   Procedure:
   A) Sclereid Concentration
   1) System Check

First turn the Feed Water valve to the open position.

With the concentrator cord plugged into an electrical outlet, push the start button on the control panel to start the system.

Observe the pressure gauge located on the mini-cleaner feed port. Check the pressure readings as the shower water cycles ON and OFF. The pressure readings should fall between 20-23 PSI regardless of whether the shower is on or off.

Allow the control system to finish its 5 minute concentration sequence.

Turn off the Feed Water valve.

Inspect, clean and reposition the sample cup.

2) Sample Preparation

Make a slush pulp so that a representative 10.0 gram (O.D. basis) sample can be withdrawn. If the 10.0 gram sample volume is not between 2½ to 3 liters then dilute to this volume by adding fresh water. If the pulp is to be immediately run through the concentrator then well mix the pulp with a stirring rod and rinse off the rod into the sample.

3) System Fill

Start with the Feed Water valve in the off position, the control timers off and the water level in the column below the 1.0 liter mark.

Ensure the pulp sample is thoroughly mixed. Very carefully pour the sample into the concentrator fill funnel. Rinse the beaker into the funnel several times using a wash bottle. Rinse the funnel several times with the wash bottle.

With the wash bottle or small water hose fill the column to the 4.0 liter mark.

4) Concentrator Operation

With the column filled to the 4.0 liter mark, turn on both the Feed Water valve and push the Start Button on the control box at the same time.

After the green start button has been pushed and the feed valve opened, the pulp sample level in the column should start dropping. Flow should be seen exiting the bottom of the cleaner into the column and exiting out the transparent tubing on the top (accept port) of the cleaner. When the fluid level reaches below the bottom level sensor, the shower water will turn on. The shower will continue to operate until the fluid level rises above the top mounted level sensor. The shower system will continue to switch on and off until the run mode timer turns off (between 3 and 4 minutes). Next, the rinse mode will activate, flushing all remaining materials (mainly sclereids and fiber) into the clean sample cup located on the base of the concentrator.

When both control timer LED lights have turned off and the water flow into the sample cup has stopped, turn off the Feed Water Valve.

Remove the sample cup and bring it to the Pulmac screen for processing.

B) Fiber Seperation—Using the Pulmac Screen

In this step, the sample is processed through the Pulmac screen to remove all residual fibers. The screen is equipped with a narrow slotted screen plate having slot widths of 0.004 thousandths of an inch. The screen is turned on and the remaining sample from the previous step is transferred into the Pulmac's sample tank. Over a period of five minutes the sample is processed through the screen and the material that is unable to pass through the slots (mostly sclereid material) is deposited in a sample cup.

After processing in the Pulmac Screen the sclereid sample is ready to be transferred onto a special embossed black filter paper.

C) Sclereid Sample Transfer

1) Filter Paper

For rapid microscopical sclereid identification and summation, round, black, ruled, 42.5 mm filter paper is needed. Start with 42.5 mm white Whatman # 4 round filter disks.

Use a new, black, permanent, waterproof felt tipped pen to color the filter paper completely black.

Before the black ink has had a chance to dry, place the blackened filter paper on a ruled embossing anvil. Rest the plastic embossing cup on top of the anvil. While firmly pressing the embossing cup down on top of the anvil, use a mallet or ball-peen hammer to swiftly strike the top of the embossing cup several times. This will transfer the image of the embossing anvil to the blackened filter paper disk. (Alternatively a hydraulic press could be used to press the image of the embossing anvil onto the filter paper).

Separate the embossing cup from the anvil and carefully remove the filter paper from the anvil.

2) Sample Transfer

Place the base of the vacuum funnel on top of a suitable sized vacuum flask.

Place a new blackened, embossed filter disk on the stainless steel screen located on the vacuum funnel base. Ensure the filter disk is well centered.

Place the top of the Vacuum funnel on the base. Be careful when positioning the funnel top not to shift the position of the filter disk directly below it.

Place the funnel spring clamp into position, firmly holding the top and base of the funnel together.

Using a high flow-rate wash bottle, wash the contaminants in the Pulmac sample cup to one side. Tip the sample cup into the vacuum funnel, to a relatively steep angle. With the wash bottle, spray water on the outside bottom edge of the screen cup (directly underneath the sclereid sample location) and carefully wash all the contaminants into the vacuum funnel. Repeat this rinse procedure.

Apply vacuum to the flask. As the fluid level drops use the wash bottle to rinse down the walls of the funnel. When the fluid level is about 1.0 cm above the filter disk observe the random positioning of the sclereids on the filter disk. If they look well spaced then continue applying vacuum until the fluid level has disappeared. If the water currents have gathered the sclereids into one area of the funnel, break the vacuum line and use the stream of water from the wash bottle to re-distribute the sclereids on the filter disk. Re-connect the vacuum line and apply enough vacuum to drain the water.

Ensure vacuum is off.

Carefully remove the funnel spring clamp.

Tip the funnel top to break the seal and lift it a few centimeters directly above the filter disk. Position the funnel horizontally (90 degrees off of its normal position) in such a way that if sclereids were scraped off the funnel bottom, they would land towards the middle of the filter disk. Use a fine stainless steel analytical spatula to scrape off any sclereids that are clinging to the inner funnel edge. Ensure they fall onto the filter disk.

Very carefully slide the spatula under the filter disk and lift the filter disk off the vacuum funnel screen. Place the filter disk into a clean plastic petri dish. Keep the sclereid sample sealed in the petri dish while transporting the sample or for storage purpose.

D) Sclereid Identification and Counting

1) Manual Counting

Carefully remove the filter disk from the plastic Petri dish and place it on a flat plate. Place the plate under a low power stereo microscope and at about 30 times total magnification proceed with the identifying and counting of sclereids. Counting should be performed in a very systematic fashion, starting at the top of the filter disk, traveling from left to right on each of the sections (the sections are created by the embossed lines), until all sclereids on each section have been identified and counted. Results are typically expressed as sclereids per gram (of pulp inspected).

2) Counting by Image Analysis

Carefully remove the filter disk from the plastic Petri dish and place it on a flat plate. Place the plate under a low power stereo microscope and at around 30 times total magnification ensure the particles (sclereids or other contaminants) are not touching each other. Carefully remove the flat plate with the filter disk on top of it and place it on an imaging system such as a special digital camera setup or flat bed scanner. A digital image is taken of the filter disk. The image is then processed with an image analysis software which detects and counts the sclereids on the filter disk. Results are typically expressed as sclereids per gram (of pulp inspected).

1. A method of isolating sclereid contaminants from pulp fibers in a pulp sample comprising:
providing an aqueous suspension of a known amount of a pulp sample in a flow chamber,
withdrawing the suspension from said chamber and entraining the suspension in an aqueous dilution stream to produce a highly diluted suspension, and
feeding the highly diluted suspension into a hydrocyclone and separating a sclereid fraction from a pulp fiber fraction in said hydrocyclone.

2. A method according to claim 1, wherein said sclereid fraction is returned to said flow chamber and recycled into said aqueous dilution stream for return to said hydrocyclone for further separation, a plurality of times, to produce a progressively sclereid enriched sclereid fraction.

3. A method according to claim 2 wherein said plurality of times is 5 to 7.

4. A method according to claim 3 wherein said plurality of times is 6.

5. A method according to claim 2 including recovering the sclereid enriched sclereid fraction with a screen plate to remove residual pulp fibers and recovering a sclereid fraction substantially free of pulp fibers.

6. A method according to claim 1, wherein said flow chamber is vertically elongate and said suspension therein flows vertically downwardly under a condition of plug flow.

7. A method according to claim 2, wherein said flow chamber is vertically elongate and said suspension therein flows vertically downwardly under a condition of plug flow.

8. A method according to claim 1, wherein said highly diluted suspension has a solids content, comprising said pulp fibers and said sclereids of not more than 0.1% by weight.

9. A method according to claim 7, wherein the suspension is withdrawn from said chamber under suction vacuum into an eductor, the suspension being entrained in said dilution stream in said eductor.

10. A method according to claim 9, wherein said aqueous dilution stream flows through said eductor to said hydrocyclone and is separated into first and second streams in said hydrocyclone, said first stream flowing out of an upper accept port of the hydrocyclone and said second stream flowing out of a lower reject port of the hydrocyclone into said flow chamber, and wherein
pulp fibers of said pulp sample are progressively conveyed in the first stream out of said upper accept port, land sclereids of said pulp sample are returned in the second stream to said flow chamber such that the suspension is progressively depleted in pulp fibers while maintaining the sclereid content of the sample.

11. A method for determining the level of sclereid contamination in a pulp comprising isolating sclereid contaminants in a process comprising:
providing an aqueous suspension of a known amount of a pulp sample in a flow chamber,
withdrawing the suspension from said chamber and entraining the suspension in an aqueous dilution stream to produce a highly diluted suspension, and
feeding the highly diluted suspension into a hydrocyclone and separating a sclereid fraction from a pulp fiber fraction in said hydrocyclone;
recovering the isolated sclereids and evaluating the sclereids as a measure of sclereid contamination of said pulp.

12. A method according to claim 11, wherein said sclereid fraction is returned to said flow chamber and recycled into said aqueous dilution stream for return to said hydrocyclone for further separation, a plurality of times, to produce a progressively sclereid enriched sclereid fraction, said flow chamber being vertically elongate and said suspension therein flowing vertically downwardly under a condition of plug flow, wherein the suspension is withdrawn from said chamber under suction vacuum into an eductor, the suspension being entrained in said dilution stream in said eductor, wherein said aqueous dilution stream flows through said eductor to said hydrocyclone and is separated into first and second streams in said hydrocyclone, said first stream flowing out of an upper accept port of the hydrocyclone and said second stream flowing out of a lower reject port of the hydrocyclone into said flow chamber, and wherein
pulp fibers of said pulp sample are progressively conveyed in the first stream out of said upper accept port, and sclereids of said pulp sample are returned in the second stream to said flow chamber such that the suspension is progressively depleted in pulp fibers while maintaining the sclereid content of the sample.

13. A method according to claim 12 wherein said plurality of times is 5 to 7.

14. An apparatus for isolating sclereid contaminants from pulp fibers in a pulp sample comprising:
a flow chamber for flow therethrough of a suspension of a known amount of the pulp sample,
a flow passage for flow of an aqueous dilution stream, and means for withdrawing the suspension from said flow chamber into said flow passage for entrainment in the aqueous dilution stream as a highly diluted suspension,
a hydrocyclone, said flow passage being in flow communication with said hydrocyclone for delivery of the highly diluted suspension to the hydrocyclone,
the hydrocyclone being adapted to separate a sclereid fraction from a pulp fiber fraction of the suspension, the hydrocyclone having a first outlet port for the pulp fiber fraction and a second outlet port for the sclereid fraction,
said second outlet port being in communication with said flow chamber for return of the sclereid fraction thereto.

15. An apparatus according to claim 14, wherein said flow chamber is vertically elongate effective to establish a plug flow of the suspension, vertically downwardly.

16. An apparatus according to claim 14, wherein the means to withdraw the suspension from the flow chamber comprises an eductor in said flow passage, effective to suction the suspension from the flow chamber into the flow passage for entrainment by the aqueous dilution stream.

17. An apparatus according to claim 15, wherein the means to withdraw the suspension from the flow chamber comprises an eductor in said flow passage, effective to suction the suspension from the flow chamber into the flow passage for entrainment by the aqueous dilution stream.

18. An apparatus according to claim 17, having a flow path for the suspension, including said flow chamber, said eductor, and said flow passage, which flow path provides for minimal mechanical impact forces on the sclereids.

19. An apparatus for determining the level of sclereid contamination in a pulp comprising an apparatus for isolating sclereid contaminants from pulp fibers in a pulp sample comprising:
a flow chamber for flow therethrough of a suspension of a known amount of the pulp sample,
a flow passage for flow of an aqueous dilution stream, and means for withdrawing the suspension from said flow chamber into said flow passage for entrainment in the aqueous dilution stream as a highly diluted suspension,
a hydrocyclone, said flow passage being in flow communication with said hydrocyclone for delivery of the highly diluted suspension to the hydrocyclone,
the hydrocyclone being adapted to separate a sclereid fraction from a pulp fiber fraction of the suspension, the hydrocyclone having a first outlet port for the pulp fiber fraction and a second outlet port for the sclereid fraction,
said second outlet port being in communication with said flow chamber for return of the sclereid fraction thereto; and
recovery means for recovery of isolated sclereids for evaluation.

20. An apparatus according to claim 19, wherein said flow chamber is vertically elongate effective to establish a plug flow of the suspension, vertically downwardly; said means to withdraw the suspension from the flow chamber comprises an eductor in said flow passage, effective to suction the suspension from the flow chamber into the flow passage for entrainment by the aqueous dilution stream; and a flow path for the suspension is defined by said flow chamber, said eductor, and said flow passage, which flow path provides for minimal mechanical impact forces on the sclereids.
